(19) United States
(12) Patent Application Publication
(10) Pub. No.: US 2019/0056818 A1
(43) Pub. Date: Feb. 21, 2019

(54) TOUCH SUBSTRATE, METHOD FOR MANUFACTURING THE SAME, AND TOUCH DISPLAY DEVICE

(71) Applicants: BOE TECHNOLOGY GROUP CO., LTD., Beijing (CN); HEFEI ZINSHENG OPTOELECTRONICS TECHNOLOGY CO., LTD, Hefei, Anhui (CN)

(72) Inventors: Jing Wang, Beijing (CN); Tsung Chieh Kuo, Beijing (CN); Xiaodong Xie, Beijing (CN); Ming Zhang, Beijing (CN); Dong Li, Beijing (CN); Qitao Zheng, Beijing (CN); Yu Zhu, Beijing (CN); Guiyu Zhang, Beijing (CN)

(21) Appl. No.: 15/767,349

(22) PCT Filed: Sep. 15, 2017
(86) PCT No.: PCT/CN2017/101925

§ 371 Date: Apr. 10, 2018

(30) Foreign Application Priority Data
Feb. 16, 2017 (CN) 201710084181.4

(51) Int. Cl. G06F 3/044

(52) U.S. Cl. CPC G06F 3/044; G06F 2203/04103; G02F 1/13338; G06F 2203/04107; G06F 2203/04111

(57) ABSTRACT

The present disclosure provides a touch substrate, a method for manufacturing the same, and a touch display device. In the touch substrate, the touch electrode layer comprises a plurality of first touch electrodes sequentially arranged in a first direction and a plurality of second touch electrodes sequentially arranged in a second direction intersected with the first direction and insulated from the first touch electrodes. The plurality of first touch electrodes and the plurality of second touch electrodes each comprise a plurality of visual touch electrodes, an intermediate portion of each visual touch electrode being located within the visual area, and two end portions of each visual touch electrode extending above the light-shielding pattern. The plurality of first touch electrodes and/or the plurality of second touch electrodes further comprise a plurality of non-visual touch electrodes located above the light-shielding pattern. The first insulating pattern is located between the touch electrode layer and the touch signal wire, the projection of the first insulating pattern in a third direction perpendicular to the first direction and the second direction being all located in the light-shielding pattern. The touch signal wires are configured to be electrically connected to all of the visual touch electrodes and part of the non-visual touch electrodes, respectively, or connected only to all of the visual touch electrodes.

### CROSS-REFERENCE TO RELATED APPLICATION

This application is a Section 371 National Stage Application of International Application No. PCT/CN2017/101925, filed on Sep. 15, 2017, entitled “TOUCH SUBSTRATE, METHOD FOR MANUFACTURING THE SAME, AND TOUCH DISPLAY DEVICE”, which claims priority to Chinese Application No. 201710084181.4, filed on Feb. 16, 2017, incorporated herein by reference in their entirety.

### BACKGROUND

### Technical Field

At least one embodiment of the present disclosure relates to the field of touch technologies, and in particular, to a touch substrate, a method for manufacturing the same, and a touch display device.

### Description of the Related Art

Various types of touch screens, such as GG (Glass-Glass or double glass), GF (Glass-Film), GFF (Glass-Film-Film or glass double-film), OGS (One glass solution), on-cell (external), in-cell (embedded), and the like, have been available on the market recently. However, regardless of the type of touch screen, there are problems such as high development costs and large types of masks involved in the production process. Even if the touch screen products have the same size, if sizes of the touch active areas of the touch screen products are changed, masks used for producing touch electrode layers of the touch screen products need to be changed accordingly, such that masks cannot be commonly used in the same processes of producing the touch screen products having the same sizes.

For example, if some touch screen products having the same models only have a slight difference in the number of product channels, the masks need to be redesigned, for example, the mask for a Tx35 and Rx64 product and mask for a Tx34 and Rx60 product need to be redesigned and procured during the design process. This leads to the problems of multiple types of Masks and high production costs in the production process.

### SUMMARY

At least one embodiment of the present disclosure provides a touch substrate, a method for manufacturing the same, and a touch display device.

According to the embodiment of one aspect of the present disclosure, there is provided a touch substrate comprising a substrate, and a light-shielding pattern, a touch electrode layer, a first insulating pattern, and touch signal wires sequentially formed on the substrate. The light-shielding pattern is located at edge portions of the substrate and defines a visual area. The touch electrode layer comprises a plurality of first touch electrodes sequentially arranged in a first direction and a plurality of second touch electrodes sequentially arranged in a second direction crossing with the first direction and insulated from the first touch electrodes. The plurality of first touch electrodes and the plurality of second touch electrodes each comprise a plurality of visual touch electrodes, an intermediate portion of each visual touch electrode being located within the visual area, and two end portions of each visual touch electrode extending above the light-shielding pattern. The plurality of first touch electrodes and/or the plurality of second touch electrodes further comprise a plurality of non-visual touch electrodes located above the light-shielding pattern. The first insulating pattern is located between the touch electrode layer and the touch signal wire, the projection of the first insulating pattern in a third direction perpendicular to the first direction and the second direction being all located within the light-shielding pattern. The touch signal wires are configured to be electrically connected to all of the visual touch electrodes and part of the non-visual touch electrodes, respectively, or connected only to all of the visual touch electrodes.

According to an embodiment of the present disclosure, the touch substrate further comprises a protection layer disposed on the touch signal wires; wherein, in the third direction, the protection layer and the first insulating pattern overlap with each other.

According to an embodiment of the present disclosure, the first insulating pattern is made of a light-shielding material.

According to an embodiment of the present disclosure, the first insulating pattern is provided to cover the touch electrodes not connected to the touch signal wire.

According to an embodiment of the present disclosure, the touch substrate further comprises an isolating layer formed on a side of the touch electrode layer opposite to the light-shielding pattern, and the projection of the isolating layer on the touch electrode layer in the third direction covers the touch electrode layer.

According to an embodiment of the present disclosure, each of the plurality of the first touch electrodes comprises a plurality of first sub touch electrodes integrally connected; each of the plurality of the second touch electrodes comprises a plurality of second sub touch electrodes spaced from each other, two adjacent second sub touch electrodes being connected by a bridge; and a second insulating pattern is provided between the bridge and the first touch electrode.

According to an embodiment of the present disclosure, an area, having a touch function, of the touch substrate comprises the visual area and an area in which the touch signal wires are connected to the non-visual touch electrodes in a non-visual area located at periphery of the visual area.

According to the embodiment of another aspect of the present disclosure, there is provided a touch display device comprising the touch substrate according to any of above embodiments.

According to the embodiment of a further aspect of the present disclosure, there is provided a method for manufacturing a touch substrate, comprising steps of:

forming a light-shielding pattern at edge portions of a substrate, the light-shielding pattern enclosing a visual area;

forming a touch electrode layer on the substrate on which the light-shielding pattern is formed, the touch electrode layer comprising a plurality of first touch electrodes sequentially arranged in a first direction and a plurality of second touch electrodes insulated from the first touch electrodes and sequentially arranged in a second direction crossing with the first direction; the plurality of first touch electrodes and the plurality of second touch electrodes each comprising a plurality of visual touch electrodes, an intermediate portion of each visual touch electrode being located within the visual area, and two end portions of each visual touch electrode extending above the light-shielding pattern; the plurality of first touch electrodes and/or the plurality of second touch electrodes also each comprising a plurality of non-visual touch electrodes located above the light-shielding pattern;

forming a first insulating pattern on the substrate on which the touch electrode layer is formed, the projection of the first insulating pattern in a third direction perpendicular to the first direction and the second direction being all located within the light-shielding pattern;

forming touch signal wires on the first insulating pattern, the touch signal wire being electrically connected to all visual touch electrodes and part of the non-visual touch electrodes, respectively, or connected only to all visual touch electrodes.

According to an embodiment of the present disclosure, the manufacturing method further comprises forming a protection layer on the touch signal wire; the same type of mask is used in exposure processes for forming the first insulating pattern and the protection layer.

According to an embodiment of the present disclosure, after forming the touch electrode layer, the method further comprises: forming an isolating layer on the substrate.

According to an embodiment of the present disclosure, the step of forming the touch electrode layer on the substrate on which the light-shielding pattern has already formed comprises steps of:

forming a first conductive film so as to form a bridge through a patterning process;

forming an insulating film so as to form a second insulating pattern on the bridge through a patterning process; and

forming a second conductive film so as to form the plurality of first touch electrodes sequentially arranged in the first direction and the plurality of second touch electrodes sequentially arranged in the second direction; and each of the plurality of the first touch electrodes comprises a plurality of first sub touch electrodes integrally connected; and each of the plurality of the second touch electrodes comprises a plurality of second sub touch electrodes spaced from each other, two adjacent second sub touch electrodes being connected by the bridge; or

forming a second conductive film so as to form the plurality of first touch electrodes sequentially arranged in the first direction and the plurality of second touch electrodes sequentially arranged in the second direction; each of the plurality of the first touch electrodes comprises a plurality of first sub touch electrodes integrally connected; and each of the plurality of the second touch electrodes comprises a plurality of second sub touch electrodes spaced from each other;

forming an insulating film so as to form a second insulating pattern between two adjacent second sub touch electrodes through a patterning process in a direction crossing with the first sub touch electrode; and

forming a first conductive film so as to form a bridge through a patterning process on the second insulating pattern, the bridge being configured to electrically connect two adjacent second sub touch electrodes.

According to an embodiment of the present disclosure, by selectively electrically connecting the non-visual touch electrodes in the non-display area at periphery of the visual area to the touch signal wire, at least part of the non-visual area may have a touch function.

### BRIEF DESCRIPTION OF THE DRAWINGS

In order to more clearly describe the technical solutions in the embodiments of the disclosure or in the relevant art, the drawings necessary for the description of the embodiments or the relevant art will be briefly described below. Obviously, the drawings in the following description are only certain embodiments of the present disclosure, and those skilled in the art may also obtain other drawings based on these drawings without any creative work, wherein:

FIG. 1 is a schematic cross-sectional view of a touch substrate according to an exemplary embodiment of the present disclosure;

FIG. 2(a) is a schematic plan view of the touch substrate shown in FIG. 1 according to an exemplary embodiment of the present disclosure;

FIG. 2(b) is a schematic plan view of the touch substrate shown in FIG. 1 according to another exemplary embodiment of the present disclosure;

FIG. 3 is a schematic cross-sectional view of a touch substrate according to another exemplary embodiment of the present disclosure;

FIG. 4 is a schematic plan view of the touch substrate shown in FIG. 3;

FIG. 5 is a schematic cross-sectional view of a touch substrate according to a further exemplary embodiment of the present disclosure;

FIG. 6 is a schematic flowchart of a method for manufacturing a touch substrate according to an exemplary embodiment of the present disclosure;

FIG. 7 is a schematic plan view of forming a light-shielding pattern on a substrate according to an exemplary embodiment of the present disclosure;

FIG. 8 is a schematic plan view of forming a touch electrode layer on the substrate on which the light-shielding pattern has already been formed according to an exemplary embodiment of the present disclosure; and

FIG. 9 is a schematic plan view of forming a first insulating pattern between the touch electrode layer and the touch signal wire on the basis of FIG. 8 according to an exemplary embodiment of the present disclosure.

### DETAILED DESCRIPTION

The technical solution of the embodiments of the present disclosure will be clearly and thoroughly described with reference to the accompanying drawings in the embodiments of the present disclosure. It is obvious that the described embodiments are merely a part of the embodiments of the present disclosure, but not all of the embodiments. All other embodiments obtained by a person of ordinary skill in the art based on the embodiments of the present disclosure without creative efforts shall fall within the protection scope of the present disclosure.

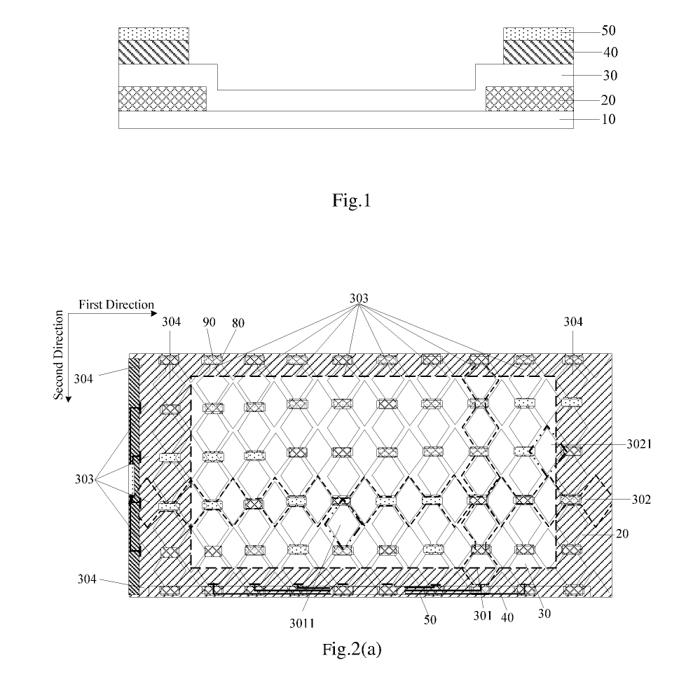

According to an exemplary embodiment of the present disclosure, a touch substrate is provided, as shown in FIGS. 1 to 5, comprising: a substrate 10, and a light-shielding pattern 20, a touch electrode layer 30, a first insulating pattern 40, and a touch signal wire 50 sequentially formed on the substrate 10. The light-shielding pattern 20 is formed on the substrate 10 and located at edge portions of the substrate 10, and defines a visual area. The touch electrode layer 30 comprises a plurality of first touch electrodes 301 sequentially arranged in a first direction and a plurality of second touch electrodes 302 sequentially arranged in a second direction intersected with the first direction and insulated from the first touch electrodes 301. For example, each of the first touch electrodes 301 and each of the second touch electrodes 302 are formed in the form of strip, respectively, and the first direction is perpendicular to the second direction. The plurality of first touch electrodes 301 and the plurality of second touch electrodes 302 each comprise a plurality of visual touch electrodes 303, wherein an intermediate portion of the visual touch electrode 303 is located within the visual area, and two end portions of the visual touch electrode 303 extend above the light-shielding pattern 20; and the plurality of first touch electrodes 301 and/or the plurality of second touch electrodes 302 also each comprise a plurality of non-visual touch electrodes located above the light-shielding pattern 20.

The first insulating pattern 40 is located between the touch electrode layer 30 and the touch signal wire 50, and a projection of the first insulating pattern 40 in a third direction perpendicular to the first direction and the second direction is all located within the light-shielding pattern 20.

In an embodiment, the touch signal wire 50 is configured to be electrically connected to all of the visual touch electrodes 303 and part of the non-visual touch electrodes 304, respectively, or connected only to all of the visual touch electrodes 303.

In the touch substrate according to an embodiment of the present disclosure, the visual area is used as a display area of a touch display device including such touch substrate. The area defined by the light-shielding pattern 20 is used as the display area, and the light-shielding pattern 20 itself is used as a non-display area. In this way, the size of the display area may be adjusted by changing the area of the light-shielding pattern 20 while the size of the touch substrate is maintained unchanged.

There is no limitation to the types of the first touch electrode 301 and the second touch electrode 302. For example, the first touch electrode 301 is used as a driving electrode, and the second touch electrode 302 is used as a sensing electrode; alternatively, the first touch electrode 301 is used as a sensing electrode, and the second touch electrode 302 is used as a driving electrode.

On this basis, a second insulating pattern may be formed at a position where the first touch electrode 301 and the second touch electrode 302 are intersected, so that the first touch electrode 301 and the second touch electrode 302 are electrically insulated from each other.

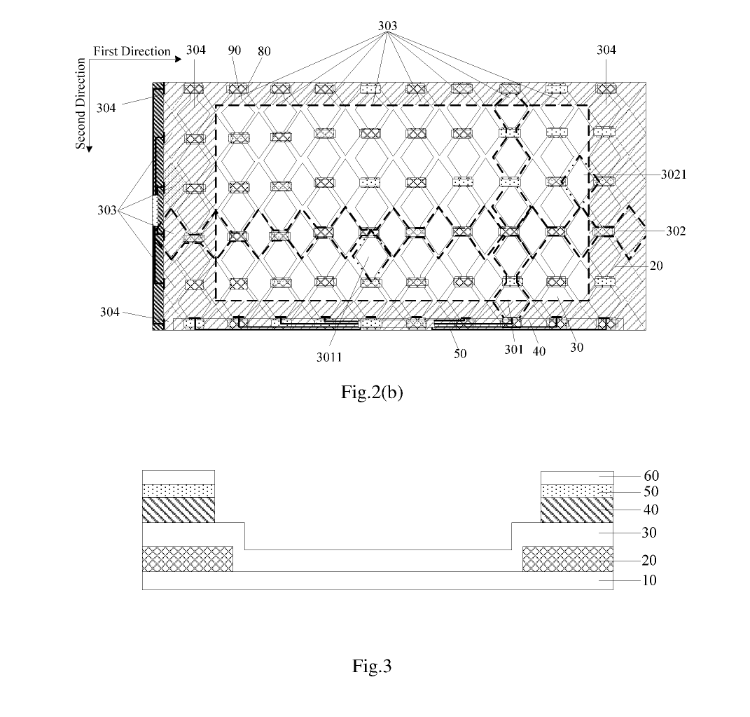

Here, as shown in FIGS. 2(a) and 2 (b), each of the plurality of the first touch electrodes 301 includes a plurality of first sub touch electrodes 3011 sequentially electrically connected. For example, the portion enclosed by the dashed line in FIGS. 2(a) and 2(b) represents one first touch electrode 301, and the portion enclosed by the dotted line represents one first sub touch electrode 3011. Similarly, each of the plurality of the second sub touch electrodes 302 includes a plurality of second sub touch electrodes 3021 sequentially electrically connected, and the portion enclosed by the dashed lines in FIGS. 2(a) and 2 (b) represent one second touch electrode 302, and the portion enclosed by the dotted line represents one second sub touch electrode 3021. The electrical connection mentioned herein may comprise an integral electrical connection or an indirect electrical connection through other connection component.

There is no limitation to the materials and shapes of the first touch electrode 301 and the second touch electrode 302. The first touch electrode 301 and the second touch electrode 302 may be made of a transparent conductive material such as ITO (Indium Tin Oxide) or IZO (Indium Zinc Oxide).

It may be appreciated that the larger the area occupied by all the first touch electrodes 301 and all the second touch electrodes 302 on the substrate 10 is, the larger the area of the touch active area of the touch substrate is. In a process of manufacturing the touch substrate, the area of the touch electrode layer 30 may be made as large as possible to ensure that a maximum touch active area (AA for short) may be created.

As shown in FIGS. 1-5, the intermediate portion of the visual touch electrode 303 is located in the visual area, and both end portions thereof extend above the light-shielding pattern 20. The non-visual touch electrodes 304 are all disposed above the light-shielding pattern 20, and all located in a non-display area outside the display area. Here, the intermediate portion and both end portions refer to the intermediate portion and both end portions of the first touch electrode 301 or the second touch electrode 302 in the length direction. In this way, regardless of whether the intermediate portion of the first touch electrode 301 or the second touch electrode 302 is entirely located in the visual area or partially in the visual area, as long as a part of the intermediate area thereof is located in the visual area, this kind of electrode is regarded as the visual touch electrode 303.

For example, as shown in FIGS. 2(a) and 2(b), a part of the first touch electrodes 301 extending in the second direction are entirely located in the non-display area in the right or left edge portion of the touch substrate, and are therefore referred to as the non-visual touch electrodes 304, whereas the other part of the first touch electrode 301 at least partially passing through the visual area are referred to as the visual touch electrodes 303. Similarly, a part of the second touch electrode 302 extending in the first direction is entirely located in the non-display area in the upper or lower edge portion of the touch substrate, and are therefore referred to as the non-visual touch electrodes 304, whereas the other part of the second touch electrode 302 at least partially passing through the visual area are referred to as the visual touch electrodes 303.

In order to ensure that the visual area may be touched, it is necessary to electrically connect the touch signal wire 50 with all of the visual touch electrodes 303. In the production process of the touch substrate, the number of touch signal wire 50 to be formed may be determined according to the size of the touch active area, and the touch signal wire 50 may be electrically connected to the non-visual touch electrodes 304 in the touch active area and the visual touch electrodes 303.

In an exemplary embodiment, if the touch product is designed such that only the visual area is required to have the touch function, as shown in FIG. 2(a), after the touch electrode layer 30 is formed, the touch signal wires 50 are produced according to the number of the first touch electrodes 301 and the number of the second touch electrodes 302 in the visual area such that the touch signal wires 50 are connected to the touch electrodes in the visual area, respectively. In another exemplary embodiment, if the touch product is designed such that both the visual area and the non-visual area are required to have touch function, as shown in FIG. 2(b), after the touch electrode layer 30 is formed, the touch signal wires 50 are produced according to the number of the first touch electrodes 301 and the number of the second touch electrodes 302 in the non-visual area having touch function and in the visual area such that the touch signal wires 50 are connected to the touch electrodes provided in the non-visual area having touch function and in the visual area, respectively. Although FIG. 2(b) shows an embodiment in which entire non-visual area has touch function, in the process of producing the touch product, there is no limitation that the entire non-visual area has the touch function, and it is also possible that only a part of the non-visual area has the touch function.

As shown in FIG. 2(a), when touch signal wires 50 are only connected to all of the visual touch electrodes 303, only the visual area has the touch function.

As shown in FIG. 2(b), the touch signal wires 50 may be connected to all of the visual touch electrodes 303 and all of the non-visual touch electrodes 304, and at this time, all of the area where the touch electrodes are provided may have the touch function.

In this way, an embodiment in which the first touch electrode 301 and the second touch electrode 302 in FIGS. 2(a) and 2(b) are respectively arranged in the first direction and the second direction perpendicular to each other is taken as an example. I the first touch electrodes 301 extending in the second direction include the non-visual touch electrodes 304, which are entirely located in the non-display area in the right or left edge portion of the touch substrate, and the visual touch electrodes 303, and the second touch electrodes 302 include only the visual touch electrodes 303, then the size of the touch active area in the left and right edge portions of the touch substrate may be adjusted by adjusting the number of the non-visual touch electrodes 304 of the first touch electrodes 301 connected to the touch signal wires 50 in the left and right edge portions, while the size of the touch active area in the upper and lower edge portions of the touch substrate may not be changed. If the second touch electrodes 302 include the non-visual touch electrodes 304, which are entirely located in the non-display area in the upper or lower edge portion of the touch substrate, and the visual touch electrodes 303, and the first touch electrodes 301 extending in the second direction include only the visual touch electrodes 303, then the size of the touch active area in the upper and lower edge portions of the touch substrate may be adjusted by adjusting the number of the non-visual touch electrodes 304 of the second touch electrodes 302 connected to the touch signal wires 50 in the upper and lower edge portions, while the size of the touch active area in the left and right edge portions of the touch substrate may not be changed. If the first touch electrodes 301 and the second touch electrodes 302 each include the non-visual touch electrodes 304 and the visual touch electrodes 303, that's to say, the upper, lower, left and right edge portions of the touch substrate each is provided with the non-visual touch electrodes 304, the size of the touch active area in the upper, lower, left and right edge portions of the touch substrate may be adjusted by adjusting the number of the non-visual touch electrodes 304 of the first touch electrodes 301 and the second touch electrodes 302 connected to the touch signal wires 50 in the upper, lower, left and right edge portions.

According to an exemplary embodiment of the present disclosure, an area having the touch function of the touch substrate comprises the visual area located in a middle portion, and an area in which the touch signal wires 50 are connected to the non-visual touch electrodes 304 in the non-visual area which is located at periphery of the visual area. In this way, by adjusting the number of the non-visual touch electrodes 304, which are connected to the touch signal wires 50 and entirely located in the non-display area, of the first touch electrodes 301 and the second touch electrodes 302, at least part of the non-visual area may have a touch function so as to adjust the size of entire touch active area.

The first insulating pattern 40 may be provided to completely cover a redundant area of the maximum touch active area on the touch substrate compared with the touch active area of the current product, or the first insulating pattern 40 may be provided only in the area where the touch signal wires 50 need to be set.

In the touch substrate according to the embodiment of the present disclosure, since the plurality of first touch electrodes 301 and/or the plurality of second touch electrodes 302 on the touch substrate each include the visual touch electrodes 303 and the non-visual touch electrodes 304, the size of the touch active area may be controlled by controlling the number of the non-visual touch electrodes 304 of the plurality of first touch electrodes 301 and/or the plurality of second touch electrodes 302 connected to the touch signal wires 50.

Based on the above embodiments, with regards to the touch products having the same size or the similar sizes, in the process of forming the same film layer of the touch electrode layers 30 of the touch substrates, it is possible to use the same type of mask to form a maximized touch active area. Then, the non-visual touch electrodes 304 in the touch area are selectively connected to the touch signal wires 50 according to the size of the touch active area on the touch substrate. Therefore, with respect to the touch products having the same size or similar sizes but having different touch active area sizes, the same type of mask may be used to form the same film layer in the process of manufacturing the touch electrode layer 30. Thus, the disclosed embodiments reduce the types of masks used in the process of manufacturing the touch substrate.

According to an embodiment of the present disclosure, as shown in FIG. 3, the touch substrate further includes a protection layer 60 disposed on the touch signal wire 50. In a third direction (the thickness direction of the substrate 10) perpendicular to the first and second directions, the protection layer 60 and the first insulating pattern 40 are overlapped with each other.

According to an embodiment of the present disclosure, there is no limitation to the material of the protection layer 60. For example, the protection layer 60 may be made of a material such as silicon nitride (SiN), silicon oxide (SiO₂), or silicon nitride oxide (SiNₓO_{y}) or the like.

According to an embodiment of the present disclosure, a protection layer 60 is disposed above the touch signal wire 50 to protect the touch signal wire 50 and prevent the touch signal wire 50 from being scratched and broken. Further, since the protection layer 60 and the first insulating pattern 40 are overlapped with each other in the thickness direction of the substrate 10, the first insulating pattern 40 and the protection layer 60 may be formed by the same type of mask, thereby reducing the types of masks to be used in the process of manufacturing the touch substrate and reducing production costs.

It should be noted that the material of the first insulating pattern 40 generally comprises silicon nitride, silicon oxide or silicon oxynitride or the like. Since the hardness of these materials is relatively small, they are easily scratched during the manufacturing process, which may cause that the touch signal wire 50 comes into contact with the touch electrode under the first insulating pattern 40. However, since the light-shielding material is relatively harder than silicon nitride, silicon oxide, or silicon oxynitride or the like, optionally, the first insulating pattern 40 may be made of light-shielding material.

In an exemplary embodiment, the light-shielding material may comprise black resin, for example.

As shown in FIG. 4, the first insulating pattern 40 covers the touch electrode that is not connected to the touch signal wire 50.

The maximum touch active area is formed by the touch electrode layer 30 on the touch substrate in the manufacturing process. Each touch substrate has its own touch active area, and the touch signal wires 50 are electrically connected to the touch electrodes in the touch active area, whereas the touch electrodes that are not connected to the touch signal wire 50 are not used to implement a touch function, so the first insulating pattern 40 covers the redundant area of the maximum touch active area compared to the required touch active area.

According to an embodiment of the present disclosure, the first insulating pattern 40 covers the first touch electrodes 301 and the second touch electrodes 302 that are not connected to the touch signal wire 50, and the touch electrode in the non-touch active area may be further prevented from being connected to the touch signal wire 50, thereby preventing the loss of the touch signal during the transmitting.

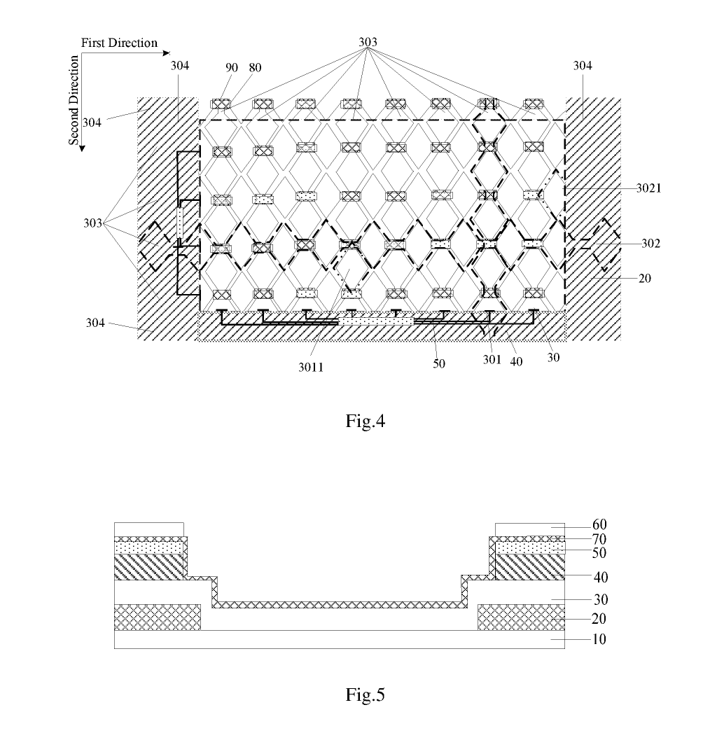

According to an embodiment of the present disclosure, as shown in FIG. 5, the touch substrate further includes an isolating layer 70 formed on a side of the touch electrode layer 30 opposite to the light-shielding pattern 20, and the projection of the isolating layer 70 on the touch electrode layer 30 in the third direction covers the touch electrode layer 30.

The material of the isolating layer 70 is not limited and may comprise, for example, SiNₓO_{y} or SiO₂.

The isolating layer 70 may be formed after the production of the touch electrode layer 30 or after the production of the first insulating pattern 40. In this case, the touch signal wire 50 passes through a vias on the isolating layer 70 in the third direction so as to electrically connect to the first touch electrodes 301 or the second touch electrodes 302. The isolating layer 70 may also be formed after the production of the touch signal wire 50. In order to simplify the manufacturing process of the touch substrate, the isolating layer 70 is formed after production of the touch signal wire 50.

The method of forming the isolating layer 70 is not limited, and for example, it may be formed by a sputtering method or a vapor deposition method.

According to an embodiment of the present disclosure, after the touch electrode layer 30 is manufactured, the isolating layer 70 is further formed, and the vanishing problem between the touch electrodes may be improved by the isolating layer 70.

In an exemplary embodiment, as shown in FIG. 2(a), 2(b) or 4, the first touch electrode 301 comprises a plurality of first sub touch electrodes 3011 integrally connected; and the second touch electrode comprises a plurality of second sub touch electrodes 3012 spaced from each other, and two adjacent second sub touch electrodes are electrically connected by a bridge 80. A second insulating pattern 90 is provided between the bridge 80 and the first sub touch electrode 3011.

The material of the bridge 80 is not limited as long as the plurality of second sub touch electrodes 3021 in the second touch electrode 302 may be electrically connected together. For example, bridge 80 may be made of a metallic material.

In addition, the material of the second insulating pattern 90 is not limited and may comprise, for example, silicon nitride, silicon oxide, silicon oxynitride, or the like.

According to an embodiment of the present disclosure, the touch electrode layer 30 includes three layers, namely, the bridge 80, the second insulating pattern 90, and the touch electrodes (first sub touch electrodes 3011 and second sub touch electrodes 3021). For touch products having the same size or similar sizes, the bridge 80 may be formed by using the same type of first mask, and the second insulating pattern 90 may be formed by using the same type of second mask, and the first touch electrodes 301 and the second touch electrodes 302 may be formed by using the same type of third mask. Therefore, it is possible to reduce the number of masks used in the process of manufacturing touch electrode layers 30 of the touch products having the same size or similar sizes.

According to another embodiment of the present disclosure, there is provided a touch display device including the touch substrate according to any one of the above embodiments.

The touch display device according to an embodiment of the present disclosure may include any display device having a touch function. More specifically, it is contemplated that the embodiments described may be implemented in or associated with a variety of electronic devices such as, but not limited to, mobile phones, wireless devices, personal data assistants (PDAs), hand-held or portable computer, GPS receiver/navigator, camera, MP3 player, camera, game console, watch, clock, calculator, TV monitor, flat panel display, computer monitor, car display (e.g. mileage Table displays, etc.), navigators, cockpit controllers and/or displays, displays of camera views (e.g., displays of rear-view cameras in vehicles), electronic photographs, electronic billboards or signs, projectors, building structures, packaging, and an aesthetic structure (for example, a display of an image of a piece of jewelry) or the like, and the electronic device may also be a display component such as a display panel.

In addition, the touch display device may comprise a Liquid Crystal Display (LCD for short) or an Organic Light-Emitting Diode (OLED for short) display. When the touch display device comprises a liquid crystal display device, the liquid crystal display device includes a liquid crystal display panel and a backlight module. The liquid crystal display panel includes an array substrate, a cell substrate, and a liquid crystal layer disposed between the array substrate and the cell substrate. The backlight module includes a backlight source, a diffusion plate, and a light guide plate, etc. . . . . When the touch display device comprises an organic electroluminescent diode display device, the touch display device includes an organic electroluminescent diode display panel, and the organic electroluminescent diode display panel includes a cathode, an anode and a light emitting layer.

According to the touch display device of the embodiment of the present disclosure, since the plurality of first touch electrodes 301 and/or the plurality of second touch electrodes 302 on the touch substrate further include non-visual touch electrodes 304, the size of the touch active area may be controlled by controlling the number of the non-visual touch electrodes 304 of the plurality of first touch electrodes 301 and/or the plurality of second touch electrodes 302 connected to the touch signal wire 50.

Based on the above embodiments, with regards to the touch products of the same size or the similar sizes, in the process of forming the same film layer of the touch electrode layers 30 of the touch substrates, it is possible to use the same type of mask to form a maximized touch active area. Then, the non-visual touch electrodes 304 in the touch area are selectively connected to the touch signal wires 50 according to the size of the touch active area on the touch substrate. Therefore, with respect to the touch products having the same size or similar sizes but having different touch active area sizes, the same type of mask may be used to form the same film layer in the process of manufacturing the touch electrode layer 30. Thus, the disclosed embodiments reduce the types of masks used in the process of manufacturing the touch substrate.

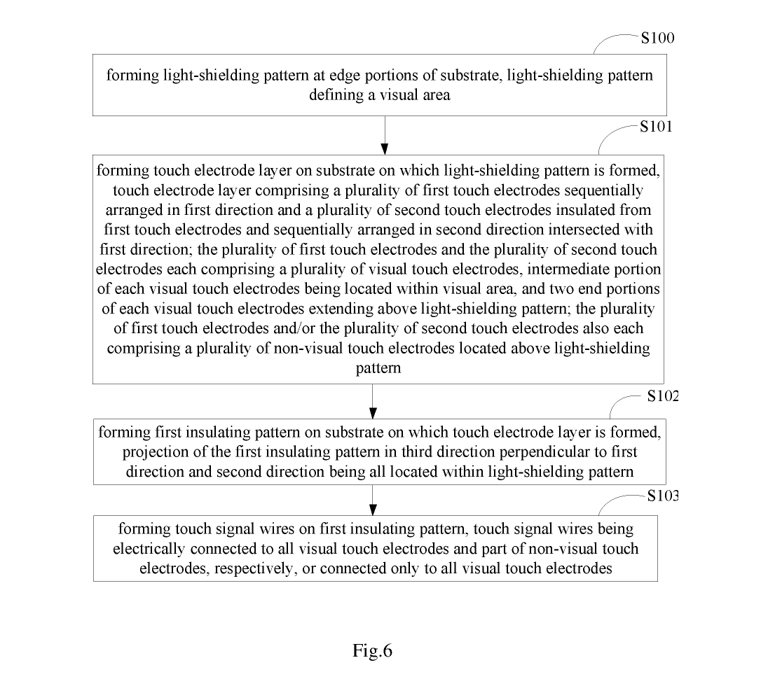

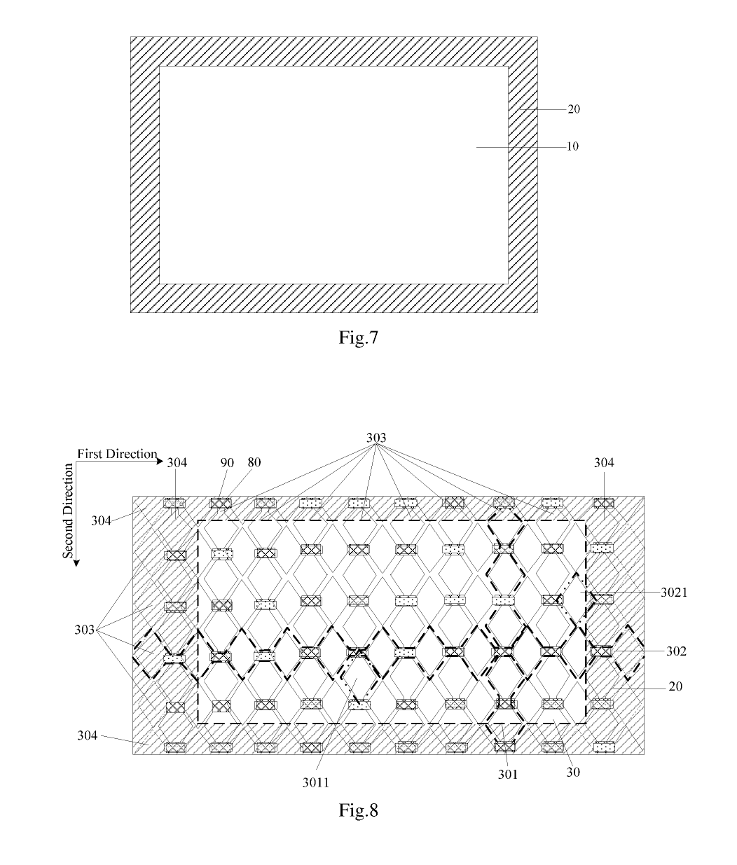

According to still another embodiment of the present disclosure, there is provided a method for manufacturing a touch substrate. As shown in FIG. 6, the method includes the a step of: S100, as shown in FIG. 7, forming a light-shielding pattern 20 at edge portions of a substrate 10, the light-shielding pattern 20 defining a visual area.

In this way, the size of the visual area may be adjusted by changing the area of the light-shielding pattern 20 in the case where the area of the touch substrate keeps constant.

It should be noted that the touch substrate motherboard is composed of a plurality of touch substrates. Those skilled in the art is appreciated that the touch substrate is formed by first forming the touch substrate motherboard, and then cutting the touch substrate motherboard in the actual manufacturing process. Based on this, the substrate 10 herein refers to a portion corresponding to one touch substrate.

The method for manufacturing a touch substrate further includes a step of: S101, as shown in FIG. 8, forming a touch electrode layer 30 on the substrate on which the light-shielding pattern has already formed, for example, by the processes of coating a film, coating photoresist, and exposing, developing and etching through a mask. The touch electrode layer 30 comprises a plurality of first touch electrodes 301 sequentially arranged in a first direction, and a plurality of second touch electrodes 302 insulated from the first touch electrodes 301 and sequentially arranged in a second direction intersected with the first direction; the plurality of first touch electrodes 301 and the plurality of second touch electrodes 302 each comprising a plurality of visual touch electrodes 303, an intermediate portion of each visual touch electrode 303 being located within the visual area, and two end portions of each visual touch electrode 303 extending above the light-shielding pattern; the plurality of first touch electrodes 301 and/or the plurality of second touch electrodes 302 also each comprising a plurality of non-visual touch electrodes 304 located above the light-shielding pattern 20.

In one embodiment, the area of the formed touch electrode layer 30 should be large enough to ensure that the formed touch active area is maximized.

It should be noted that the touch electrode layer 30 specifically includes three layers, which are: a bridge 80, a second insulating pattern 90 and touch electrodes (first sub touch electrodes 3011 and second sub touch electrodes 3021), respectively. Here, the bridge 80 may be formed first, then the second insulating pattern 90 may be formed, and finally the touch electrodes may be formed; or the touch electrodes may be formed first, then the second insulating pattern 90 may be formed, and finally the bridge 80 may be formed.

The specific formation process of the touch electrode layer 30 is described in detail below.

First, a first conductive film is formed so as to form the bridge 80 through a patterning process including the processes of coating photoresist, and exposing, developing and etching by a first mask. The material of the first conductive film is not limited, and for example, it may comprise a metal material or an ITO material. On this basis, the first conductive film may be formed by magnetron sputtering or vacuum evaporation.

Next, an insulating film is formed so as to form a second insulating pattern 90 on the bridge through a patterning process including the processes of coating photoresist, and exposing and developing by a second mask.

Finally, a second conductive film is formed so as to form a plurality of first touch electrodes 301 sequentially arranged in a first direction and a plurality of second touch electrodes 302 sequentially arranged in a second direction through a patterning process including the processes of coating photoresist, and exposing, developing and etching by a third mask. Each of the plurality of the first touch electrodes 301 comprises a plurality of first sub touch electrodes 3011 integrally connected; and each of the plurality of the second touch electrodes 302 comprises a plurality of second sub touch electrodes 3021 spaced from each other, two adjacent second sub touch electrodes 3021 being electrically connected by the bridge 80. Here, the material for the second conductive film may comprise a transparent conductive material such as ITO (Indium Tin Oxide) or IZO (Indium Zinc Oxide).

In another embodiment, first, a second conductive film is formed so as to form a plurality of first touch electrodes 301 sequentially arranged in a first direction and a plurality of second touch electrodes 302 sequentially arranged in a second direction through a patterning process including the processes of coating photoresist, and exposing, developing and etching by the third mask. Each of the plurality of the first touch electrodes 301 comprises a plurality of first sub touch electrodes 3011 integrally electrically connected; and each of the plurality of the second touch electrodes 302 comprises a plurality of second sub touch electrodes 3021 spaced from each other.

Next, an insulating film is formed so as to form a second insulating pattern 90 between the two adjacent second sub touch electrodes 3021 through a patterning process including the processes of coating photoresist, and exposing, developing by the second mask in a direction intersected with the first sub touch electrode 301;

Finally, a first conductive film is formed so as to form a bridge 80 through a patterning process including the processes of coating photoresist, and exposing, developing and etching by the first mask on the second insulating pattern 90, and the bridge 80 is configured to electrically connect the two adjacent second sub touch electrodes 3021.

Based on the above embodiment, as for the touch substrates having the same size or similar sizes, regardless of the change in the size of the touch active area, the bridge 80 may be produced by using the same type of first mask, and the second insulating pattern 90 may be made by using the same type of second mask, and the first touch electrodes 301 and the second touch electrodes 302 may be made by using the same type of third mask.

Further, an embodiment in which the first touch electrode 301 and the second touch electrode 302 in FIGS. 2(a) and 2(b) are respectively arranged in the first direction and the second direction perpendicular to each other is taken as an example. If the first touch electrodes 301 include the non-visual touch electrodes 304 and the visual touch electrodes 303, whereas the second touch electrodes 302 include only the visual touch electrodes 303, then the size of the touch active area in the left and right edge portions of the touch substrate may be adjusted by adjusting the number of the non-visual touch electrodes 304 of the first touch electrodes 301 connected to the touch signal wires 50, while the size of the touch active area in the upper and lower edge portions of the touch substrate may not be changed. If the second touch electrodes 302 include the non-visual touch electrodes 304 and the visual touch electrodes 303, whereas the first touch electrodes 301 include only the visual touch electrodes 303, then the size of the touch active area in the upper and lower edge portions of the touch substrate may be adjusted by adjusting the number of the non-visual touch electrodes 304 of the second touch electrodes 302 connected to the touch signal wires 50 in the upper and lower edge portions, while the size of the touch active area in the left and right edge portions of the touch substrate may not be changed. If the first touch electrodes 301 and the second touch electrodes 302 each include the non-visual touch electrodes 304 and the visual touch electrodes 303, the size of the touch active area in the upper, lower, left and right edge portions of the touch substrate may be adjusted by adjusting the number of the non-visual touch electrodes 304 of the first touch electrodes 301 and the second touch electrodes 302 connected to the touch signal wires 50.

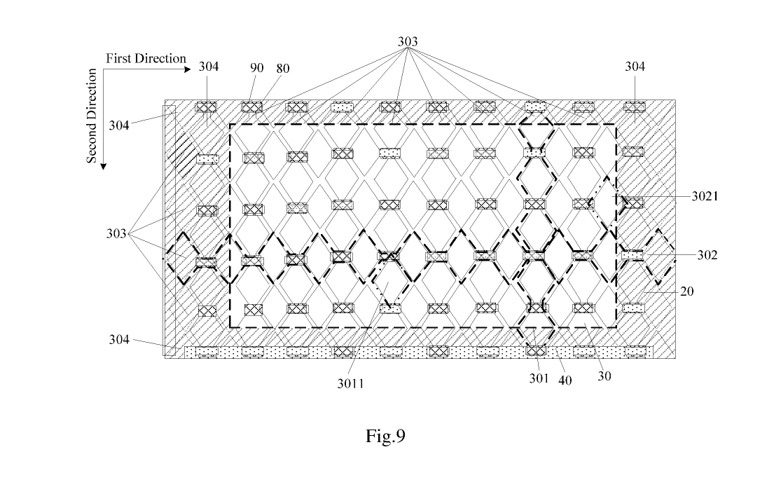

The method for manufacturing a touch substrate further includes a step of: S102, as shown in FIG. 9, forming a first insulating pattern 40 on the substrate on which the touch electrode layer has already formed, and the projection of the first insulating pattern 40 in a third direction (i.e. the thickness direction of the substrate) is all located within the light-shielding pattern 20.

In this way, as shown in FIG. 4, the first insulating pattern 40 may be provided to completely cover a redundant area of the maximum touch active area compared with the touch active area of the current product. Alternatively, as shown in FIGS. 2 and 9, the first insulating pattern 40 may be provided only in the area where the touch signal wire 50 needs to be set so as to facilitate the subsequent formation of the touch signal wire 50 on the first insulating pattern 40.

The method for manufacturing a touch substrate further includes a step of: S103, as shown in FIGS. 2 and 4, forming the touch signal wires 50 on the first insulating pattern 40, and the touch signal wires 50 are electrically connected to all visual touch electrodes 303 and part of the non-visual touch electrodes 304, respectively, or connected only to all visual touch electrodes 303.

Although the area of the touch electrode layer 30 formed on the touch substrate in the step S101 is relative large, only the area where the touch electrodes are connected to the touch signal wires 50 has a touch function. Therefore, in the process of manufacturing the touch substrate, the number of touch signal wires 50 to be formed may be controlled based on the size of the touch active area, such that the touch signal wires 50 are connected to the touch electrodes in the actual touch active area.

It should be noted that since the visual area of the touch substrate have a touch function, the touch signal wires 50 should be connected to all visual touch electrodes 303. When touch signal wires 50 are only connected to all visual touch electrodes 303, only the visual area has the touch function. When the touch signal wires 50 are further connected to part of the non-visual touch electrodes 304 in addition to all the visual touch electrodes 303, the area where the non-visual touch electrode 304 is connected to the touch signal wires 50 also has the touch function. Furthermore, the touch signal wire 50 may be connected to all the visual touch electrodes 303 and all the non-visual touch electrodes 304. In this case, the area where the touch electrode is provided may have the touch function.

In the method for manufacturing a touch substrate according to the embodiment of the present disclosure, since the plurality of first touch electrodes 301 and/or the plurality of second touch electrodes 302 on the touch substrate also include the non-visual touch electrodes 304, the size of the touch active area may be controlled by controlling the number of the non-visual touch electrodes 304 of the plurality of first touch electrodes 301 and/or the plurality of second touch electrodes 302 connected to the touch signal wires 50.

Based on the above embodiments, with regards to the touch products of the same size or the similar sizes, in the process of forming the same film layer of the touch electrode layers 30 of the touch substrates, the same type of mask may be used to form a maximized touch active area. Then, the non-visual touch electrodes 304 in the touch area are selectively connected to the touch signal wires 50 according to the size of the touch active area on the touch substrate. Therefore, with respect to the touch products having the same size or similar sizes but having different touch active area sizes, the same type of mask may be used to form the same film layer in the process of manufacturing the touch electrode layer 30. Thus, the disclosed embodiments reduce the types of masks used in the touch substrate manufacturing process.

According to an embodiment, as shown in FIG. 3, the above method further includes a step of forming a protection layer 60 on the touch signal wire 50. The same type of mask is used in the exposure processes for forming the first insulating pattern and the protection layer.

There is no limitation to the material of the protection layer 60. For example, the protection layer 60 may be made of a material such as silicon nitride (SiN), silicon oxide (SiO₂), or silicon nitride oxide (SiNₓO_{y}) or the like.

According to an embodiment of the present disclosure, the protection layer 60 is disposed above the touch signal wire 50 so as to protect the touch signal wire 50 and prevent the touch signal wire 50 from scratching and breaking. Further, the same type of mask is used in the exposure processes for forming the first insulating pattern and the protection layer, thereby reducing the types of masks to be used in the touch substrate manufacturing process and reducing production costs.

In an embodiment, by selectively electrically connecting the non-visual touch electrodes in non-visual area at periphery of the visual area to the touch signal wires, at least part of the non-visual area may have a touch function. In this way, in addition to the visual area having a touch function, at least part of the non-visual area also has a touch function, so as to adjust the size of the entire touch active area.

In an embodiment, as shown in FIG. 5, the method for manufacturing the touch electrode further includes a step of forming an isolating layer 70 on the substrate 10 after forming the touch electrode layer 30.

The material of the isolating layer 70 is not limited and may comprise, for example, SiNₓO_{y} or SiO₂. The method of forming the isolating layer 70 is not limited, and for example, it may be formed by a sputtering method or a vapor deposition method.

Further, the isolating layer 70 may be formed after forming the touch electrode layer 30 or after forming the first insulating pattern 40. In this case, the touch signal wires 50 pass through the vias on the isolating layer 70 to electrically connect to the first touch electrodes 301 or the second touch electrodes 302. The isolating layer 70 may also be formed after forming the touch signal wires 50. In order to simplify the manufacturing process of the touch substrate, the isolating layer 70 is fabricated after forming the touch signal wire 50.

According to an embodiment of the present disclosure, after the touch electrode layer 30 is manufactured, the isolating layer 70 is further formed, and the vanishing problem between the touch electrodes may be improved by the isolating layer 70.

In the touch substrate, the method for manufacturing the same and the touch display device according to the embodiments of the present disclosure, since the plurality of first touch electrodes and/or the plurality of second touch electrodes on the touch substrate each include the visual touch electrodes and the non-visual touch electrodes, the size of the touch active area may be controlled by controlling the number of the non-visual touch electrodes of the plurality of first touch electrodes and/or the plurality of second touch electrodes connected to the touch signal wires. In this way, with regards to the touch products of the same size or the similar sizes, in the process of forming the same film layer of the touch electrode layers of the touch substrates, the same type of mask may be used to form a maximized touch active area. Then, the non-visual touch electrodes in the touch area are selectively connected to the touch signal wire according to the size of the touch active area on the touch substrate. Therefore, with respect to the touch products having the same size or similar sizes but having different touch active area sizes, the same type of mask may be used to form the same film layer in the process of manufacturing the touch electrode layer.

The foregoing descriptions are merely specific embodiments of the present disclosure, but the protection scope of the present disclosure is not limited thereto. Any person skilled in the art may easily envisage that any change or replacement within the technical scope disclosed by the present disclosure should be within the protection scope of the disclosure. Therefore, the protection scope of the present disclosure should be based on the protection scope of the claims.

1. A touch substrate comprising a substrate, and a light-shielding pattern, a touch electrode layer, a first insulating pattern, and touch signal wires formed on the substrate, wherein:
the light-shielding pattern is located at edge portions of the substrate to define a visual area;
the touch electrode layer comprises a plurality of first touch electrodes sequentially arranged in a first direction and a plurality of second touch electrodes sequentially arranged in a second direction intersected with the first direction and insulated from the first touch electrodes;
the plurality of first touch electrodes and the plurality of second touch electrodes each comprise a plurality of visual touch electrodes, an intermediate portion of each visual touch electrode being located within the visual area, and two end portions of each visual touch electrode extending above the light-shielding pattern;
the plurality of first touch electrodes and/or the plurality of second touch electrodes further comprise a plurality of non-visual touch electrodes located above the light-shielding pattern;
the first insulating pattern is located between the touch electrode layer and the touch signal wires, the projection of the first insulating pattern in a third direction perpendicular to the first direction and the second direction being all located within the light-shielding pattern; and
the touch signal wires are configured to be electrically connected to all of the visual touch electrodes and part of the non-visual touch electrodes, respectively, or connected only to all of the visual touch electrodes.

2. The touch substrate of claim 1, further comprising a protection layer on the touch signal wires;
wherein, in the third direction, the protection layer and the first insulating pattern are overlapped with each other.

3. The touch substrate according to claim 1, wherein the first insulating pattern is made of a light-shielding material.

4. The touch substrate according to claim 1, wherein the first insulating pattern is provided to cover the touch electrodes not connected to the touch signal wire.

5. The touch substrate according to claim 1, further comprising an isolating layer formed on a side of the touch electrode layer opposite to the light-shielding pattern, wherein a projection of the isolating layer on the touch electrode layer in the third direction covers the touch electrode layer.

6. The touch substrate according to claim 1, wherein each of the plurality of the first touch electrodes comprises a plurality of first sub touch electrodes integrally connected;
wherein each of the plurality of the second touch electrodes comprises a plurality of second sub touch electrodes spaced from each other, two adjacent second sub touch electrodes being connected by a bridge; and
wherein a second insulating pattern is provided between the bridge and the first touch electrodes.

7. The touch substrate according to claim 1, wherein an area, having a touch function, of the touch substrate comprises the visual area and a non-visual area in which the touch signal wires are connected to the non-visual touch electrodes located at a periphery of the visual area.

8. A touch display device comprising the touch substrate according to claim 1.

9. A method for manufacturing a touch substrate, comprising steps of:
forming a light-shielding pattern at edge portions of a substrate, the light-shielding pattern defining a visual area;
forming a touch electrode layer on the substrate on which the light-shielding pattern is formed, the touch electrode layer comprising a plurality of first touch electrodes sequentially arranged in a first direction and a plurality of second touch electrodes insulated from the first touch electrodes and sequentially arranged in a second direction intersected with the first direction; the plurality of first touch electrodes and the plurality of second touch electrodes each comprising a plurality of visual touch electrodes, an intermediate portion of each visual touch electrode being located within the visual area, and two end portions of each visual touch electrode extending above the light-shielding pattern; the plurality of first touch electrodes and/or the plurality of second touch electrodes also each comprising a plurality of non-visual touch electrodes located above the light-shielding pattern;
forming a first insulating pattern on the substrate on which the touch electrode layer is formed, the projection of the first insulating pattern in a third direction perpendicular to the first direction and the second direction being all located within the light-shielding pattern; and
forming touch signal wires on the first insulating pattern, the touch signal wires being electrically connected to all visual touch electrodes and part of the non-visual touch electrodes, respectively, or connected only to all visual touch electrodes.

10. The manufacturing method according to claim 9, further comprising: forming a protection layer on the touch signal wires;
wherein the same type of mask is used in exposure processes of forming the first insulating pattern and the protection layer.

11. The manufacturing method according to claim 9, wherein after forming the touch electrode layer, the method further comprises: forming an isolating layer on the substrate.

12. The manufacturing method according to claim 9, wherein the step of forming the touch electrode layer on the substrate on which the light-shielding pattern is formed comprises steps of:
forming a first conductive film so as to form a bridge through a patterning process;
forming an insulating film so as to form a second insulating pattern on the bridge through a patterning process; and
forming a second conductive film so as to form the plurality of first touch electrodes sequentially arranged in the first direction and the plurality of second touch electrodes sequentially arranged in the second direction; and each of the plurality of the first touch electrodes comprises a plurality of first sub touch electrodes integrally connected; and each of the plurality of the second touch electrodes comprises a plurality of second sub touch electrodes spaced from each other, two adjacent second sub touch electrodes being connected by the bridge; or
forming a second conductive film so as to form the plurality of first touch electrodes sequentially arranged in the first direction and the plurality of second touch electrodes sequentially arranged in the second direction; each of the plurality of the first touch electrodes comprises a plurality of first sub touch electrodes integrally connected; and each of the plurality of the second touch electrodes comprises a plurality of second sub touch electrodes spaced from each other;
forming an insulating film so as to form a second insulating pattern between the two adjacent second sub touch electrodes through a patterning process in a direction intersected with the first sub touch electrode; and
forming a first conductive film so as to form a bridge through a patterning process on the second insulating pattern, the bridge being configured to electrically connect two adjacent second sub touch electrodes.

13. The manufacturing method according to claim 9, wherein the touch signal wires are adjusted to be connected to the non-visual touch electrodes in a non-visual area located at periphery of the visual area such that at least part of the non-visual area has a touch function.

14. The touch display device of claim 8, further comprising a protection layer on the touch signal wires:
wherein, in the third direction, the protection layer and the first insulating pattern are overlapped with each other.

15. The touch display device according to claim 8, wherein the first insulating pattern is made of a light-shielding material.

16. The touch display device according to claim 8, wherein the first insulating pattern is provided to cover the touch electrodes not connected to the touch signal wire.

17. The touch display device according to claim 8, further comprising an isolating layer formed on a side of the touch electrode layer opposite to the light-shielding pattern, and the projection of the isolating layer on the touch electrode layer in the third direction covers the touch electrode layer.

18. The touch display device according to claim 8, wherein each of the plurality of the first touch electrodes comprises a plurality of first sub touch electrodes integrally connected:
wherein each of the plurality of second touch electrodes comprises a plurality of second sub touch electrodes spaced from each other, two adjacent second sub touch electrodes being connected by a bridge; and
wherein a second insulating pattern is provided between the bridge and the first touch electrodes.

19. The touch display according to claim 8, wherein an area, having a touch function, of the touch substrate comprises a visual area and a non-visual area in which the touch signal wires are connected to the non-visual touch electrodes located at the periphery of the visual area.
